(19) United States
(12) Patent Application Publication
(10) Pub. No.: US 2025/0100916 A1
(43) Pub. Date: Mar. 27, 2025

(54) METHOD FOR REMOVING INORGANIC SUBSTANCES FROM WASTEWATER

(71) Applicant: INDUSTRIAL TECHNOLOGY RESEARCH INSTITUTE, Hsinchu (TW)

(72) Inventors: Mao-Sung LEE, Hsinchu City (TW); Teh-Ming LIANG, Tainan City (TW); Wang-Kuan CHANG, Hsinchu City (TW)

(73) Assignee: INDUSTRIAL TECHNOLOGY RESEARCH INSTITUTE, Hsinchu (TW)

(21) Appl. No.: 18/435,560

(22) Filed: Feb. 7, 2024

(30) Foreign Application Priority Data
Sep. 23, 2023 (TW) 112136443

(51) Int. Cl. C02F 1/52; B01D 9/00; C02F 101/14; C02F 101/20

(52) U.S. Cl. CPC C02F 1/5236; B01D 9/0036; B01D 2009/0086; C02F 2001/5218; C02F 2101/14; C02F 2101/20

(57) ABSTRACT

A method for removing inorganic substances from wastewater is provided. The method includes: providing a fluidized bed reactor, wherein carriers are added into the fluidized bed reactor, and the carriers includes polyvinylidene fluoride (PVDF), ethylene tetrafluoroethylene (ETFE), alumina (Al₂O₃) with purity more than 95 wt %, or combinations thereof; introducing the wastewater containing the inorganic substances and a first reagent into the fluidized bed reactor; fluidizing the carriers in the fluidized bed reactor, and making the inorganic substances in the wastewater reacting with the first reagent to form crystals, wherein the crystals are formed on the outer surfaces of the carriers.

This application claims the benefit of Taiwan application Serial No. 112136443, filed Sep. 23, 2023, the disclosure of which is incorporated by reference herein in its entirety.

### TECHNICAL FIELD

The disclosure relates to a method for removing inorganic substances from wastewater.

### BACKGROUND

As human demand for electronic products increases, the problem of environmental pollution caused by a large amount of industrial wastewater produced in the manufacturing process of electronic products becomes much more serious. Common pollutants in industrial wastewater include inorganic substances such as fluorine, nitrogen, phosphate, arsenic, calcium, nickel, magnesium, iron, lead, cobalt, zinc, cadmium, manganese and copper. Currently, wastewater is usually treated through a chemical coagulation/sedimentation method. The chemical coagulation/sedimentation method uses coagulants and/or flocculants and/or polymer to enhance pollutants precipitate at the bottom of the treatment tank (as sludge) to reduce amount of pollutants in the wastewater. However, such a treatment process requires a large amount of chemicals and will produce a huge amount of sludge; the costs of chemicals and sludge treatment are very high. Moreover, the inorganic substances recovered from sludge have low purity and are difficult to reuse, leading to problems of resource waste and environmental pollution.

Therefore, how to improve methods for treating wastewater containing inorganic substances has become an important issue that cannot be ignored.

### SUMMARY

The disclosure is directed to a method for removing inorganic substances from wastewater, which effectively reduces the amount of inorganic substances in wastewater by using reusable carriers, and can recover inorganic ions from the wastewater to form high-purity inorganic substances.

According to one embodiment, a method for removing inorganic substances from wastewater is provided. The method includes: providing a fluidized bed reactor, wherein carriers are added into the fluidized bed reactor, and the carriers comprises polyvinylidene fluoride (PVDF), ethylene tetrafluoroethylene (ETFE), alumina (Al₂O₃) with purity higher than 95 wt %, or combinations thereof; introducing the wastewater containing the inorganic substances and a first reagent into the fluidized bed reactor; fluidizing the carriers in the fluidized bed reactor, and making the inorganic substances in the wastewater reacting with the first reagent to form crystals, wherein the crystals are formed on the outer surfaces of the carriers.

### BRIEF DESCRIPTION OF THE DRAWINGS

FIG. 1 shows a schematic view of a fluidized bed reactor according to an embodiment of the present disclosure.

FIG. 2 shows a schematic view of a crystal and a carrier according to an embodiment of the present disclosure.

FIG. 3 shows a schematic view of a crystal dissolving tank according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Embodiments of the present disclosure are directed to a device and a method for treating fluid. Embodiments of the present disclosure can be applied to, but not limited to, treatment of wastewater containing inorganic substances. For example, embodiments of the present disclosure can be applied to removal of at least part of inorganic substances from wastewater and/or recovering at least part of inorganic substances from wastewater. Specifically, the embodiments of the present disclosure relate to use of fluidized bed crystallization (FBC) technology to crystallize inorganic substances in wastewater on carriers so as to remove at least part of inorganic substances from wastewater.

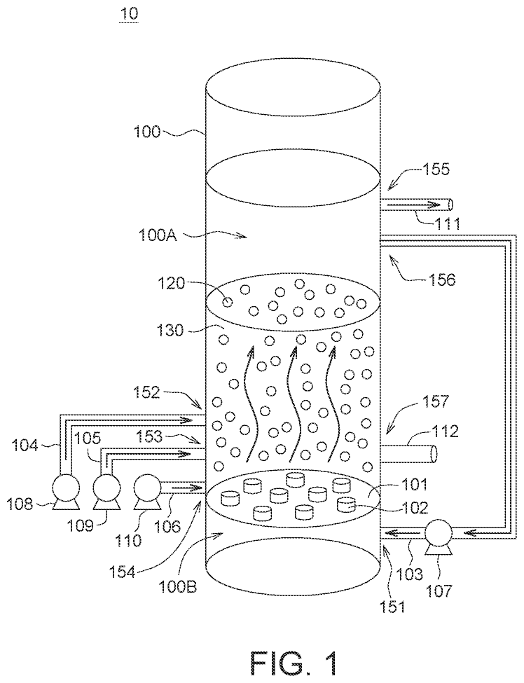

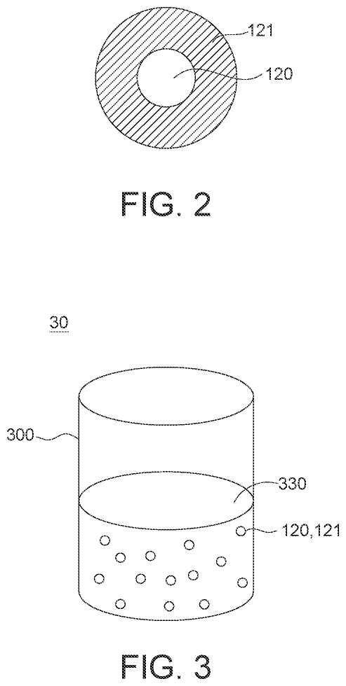

Referring to FIG. 1 to FIG. 3, FIG. 1 shows a schematic view of a fluidized bed reactor 10 according to an embodiment of the present disclosure, FIG. 2 shows a schematic view of a crystal 121 and a carrier 120 according to an embodiment of the present disclosure, and FIG. 3 shows a schematic view of a crystal dissolving tank 30 according to an embodiment of the present disclosure. As shown in FIG. 1, the fluidized bed reactor 10 includes a tank 100, a spacer 101, flow distributors 102, a reflux inlet 151, inlets 152˜154, an outlet 155, a reflux outlet 156, a crystal outlet 157, pipes 103˜106, 111 and 112, and pumps 107˜110. The tank 100 can accommodate fluid 130. The spacer 101 is situated inside the tank 100 and divides the inner space of the tank 100 into a first space 100A and a second space 100B. In the present embodiment, the first space 100A is above the second space 100B, but the present disclosure is not limited thereto. The flow distributors 102 are arranged on the spacer 101. The reflux inlet 151 connects the second space 100B of the tank 100. The inlets 152˜154, the outlet 155 and the reflux outlet 156 connect with the first space 100A of the tank 100. The outlet 155 and the flux inlet 156 may be arranged above the inlets 152˜154. The pipe 111 connects the outlet 155. The pipe 112 connects the crystal outlet 157. The pipe 103 connects between the reflux inlet 151 and the reflux outlet 156. The pump 107 connects the pipe 103. The pump 107 may be used to adjust the flow rate of the fluid in the pipe 103. The pipe 104 connects the inlet 152. The pump 108 connects the pipe 104. The pump 108 may be used to adjust the flow rate of the fluid in the pipe 104. The pipe 105 connects the inlet 153. The pump 109 connects the pipe 105. The pump 109 may be used to adjust the flow rate of the fluid in the pipe 105. The pipe 106 connects the inlet 154. The pump 110 connects the pipe 106. The pump 110 may be used to adjust the flow rate of the fluid in the pipe 106. The power sources required for the pumps 107˜110 to control flow rate are electricity.

In other embodiments, the fluidized bed reactor 10 does not include the reflux outlet 156; one end of the pipe 103 connects the reflux inlet 151 and the other end of the pipe 103 connects other storage system such as a raw material storage device, a reagent storage device, and a wastewater storage device. In other embodiments, the fluidized bed reactor 10 includes more or less inlets and/or more or less outlets.

The fluidized bed reactor 10 includes carriers 120 in the first space 100A of the tank 100. The flow distributors 102 allows the fluid 130 to flow in the tank so that the carriers 120 are fluidized uniformly. The constituents of the fluid 130 can react to form crystals 121 on the outer surfaces of the carriers 120, as shown in FIG. 2. The crystal 121 may be formed on at least part of the outer surface of the carrier 120. The crystal 121 may cover the carrier 120. FIG. 2 shows that the carrier 120 has a spherical shape, but the present disclosure is not limited thereto; the carrier 120 may have an ellipsoidal shape, a cylindrical shape, a cubic shape, or a rectangular parallelepiped shape.

As shown in FIG. 3, the crystal dissolving tank 30 includes a dissolving tank body 300. The dissolving tank body 300 can accommodate fluid 330. The dissolving tank body 300 may be used to treat the crystals 121 on the outer surfaces of the carriers 120. For example, the dissolving tank body 300 can be used to dissolve the crystals 121 to recover the substances contained in the crystals 121.

The fluidized bed reactor 10 and the crystal dissolving tank 30 according to the embodiments of the present disclosure can be applied to treat wastewater and recover inorganic substances crystallized on the carriers. For example, the fluidized bed reactor 10 and the crystal dissolving tank 30 according to the embodiments of the present disclosure can be applied to remove at least part of inorganic substances from wastewater containing inorganic substances and/or recover at least part of inorganic substances from wastewater containing inorganic substances. For example, the fluidized bed reactor 10 and the crystal dissolving tank 30 according to the embodiments of the present disclosure can be applied to recover inorganic substances and the carriers by adding acid to dissolve the crystals on the carriers. The method is described as follows.

A fluidized bed reactor 10, in which carriers 120 are added, and a crystal dissolving tank 30 are provided. The carriers 120 may be solid. The carriers 120 have a particle size of 0.1 mm to 2 mm. The carriers 120 have a density greater than 1 g/cm³, thereby preventing the carriers from flowing out of the fluidized bed reactor 10 from the pipe 111 located at the upper part of the tank, thereby reducing the crystallization efficiency. The carriers may include organic carriers, inorganic carriers or a combination thereof. The organic carriers include polyvinylidene fluoride (PVDF) and ethylene tetrafluoroethylene (ETFE). The inorganic carriers include alumina (Al₂O₃) with purity more than 95 wt %.

In an embodiment, the carriers 120 are polyvinylidene fluoride (PVDF) or ethylene tetrafluoroethylene (ETFE), and the carriers 120 have a particle size of 0.1 mm to 2 mm and a density between 1.5 g/cm³ and 2 g/cm³. In an embodiment, the carriers 120 are made of alumina (Al₂O₃) with purity more than 95 wt %, and the carriers 120 have a particle size of 0.1 mm to 1 mm and a density between 2.6 g/cm³ and 4 g/cm³. In an embodiment, the carriers 120 are made of white fused alumina (WFA; the composition of white fused alumina contains more than 99.2 wt % alumina) or brown fused alumina (BFA; the composition of brown fused alumina contains more than 95 wt % alumina), and the carriers 120 have a particle size of 0.1 mm to 1 mm and a density between 2.6 g/cm³ and 4 g/cm³.

The wastewater containing the inorganic substances is introduced into the first space 100A of the tank 100 through the pipe 104 and the inlet 152. The first reagent is introduced into the first space 100A of the tank 100 through the pipe 105 and the inlet 153. The inorganic substances in the wastewater may include fluoride ion, nitrogen ion, phosphate ion, arsenic ion, calcium ion, nickel ion, magnesium ion, iron ion, lead ion, cobalt ion, zinc ion, cadmium ion, manganese ion, copper ion, or combinations thereof. The first reagent may include halide, carbonate, bicarbonate, or combinations thereof. Halide may include calcium halide. In an embodiment, the first reagent includes calcium chloride (CaCl₂), sodium carbonate (Na₂CO₃), sodium bicarbonate (NaHCO₃), or combinations thereof. In an embodiment, the first reagent includes an alkaline reagent such as sodium hydroxide (NaOH).

In embodiments according to the present disclosure, the pH value of the fluidized bed crystallization reaction is maintained at a pH value optimal for treating the pollutant. In order to maintain the pH value in an optimal range, an alkaline reagent can be introduced into the first space 100A of the tank 100 through the pipe 106 and the inlet 154 to adjust the pH value of the fluid. The alkaline reagent, the waste water and the first reagent can be mixed in the tank 100. For example, the alkaline reagent is a sodium hydroxide solution. In an embodiment, dilution water can be introduced into the first space 100A of the tank 100 through the pipe 106 and the inlet 154. The fluid 130 in the tank 100 includes the waste water and the first reagent. The fluid 130 in the tank 100 may further include an alkaline reagent and/or dilution water.

Part of the fluid 130 can flow to the second space 100B of the tank 100 through the reflux outlet 156, the pipe 103 and the reflux inlet 151, and then flow to the first space 100A of the tank 100 through the flow distributors 102. The carriers 120 are fluidized by the movement of the fluid 130 in the tank 100. The fluid 130 and the carriers 120 flow and mix in the tank 100, and a fluidized bed crystallization reaction occurs. The fluidized carriers 120 have a large surface area for reaction, and thus the crystallization efficiency can be improved.

In the fluidized bed crystallization reaction, the wastewater and the first reagent react to form crystals 121 and a treated solution. Specifically, the crystals 121 are formed by a reaction of inorganic substances in wastewater and the first reagent, and thus at least part of the inorganic substances can be removed from the wastewater. The crystals 121 are solid. The crystal 121 is formed on at least part of the outer surface of the carrier 120. The amount of the inorganic substances in the treated solution is less than the amount of the inorganic substances in the wastewater (i.e. the wastewater before the fluidized bed crystallization reaction occurs) since at least part of the inorganic substances in the wastewater have formed crystals. During the treatment, part of the treated solution can flow to the second space 100B of the tank 100 through the reflux outlet 156, the pipe 103 and the reflux inlet 151, and then flow to the first space 100A of the tank 100 through the flow distributors 102, which helps to achieve efficient and stable crystallization reaction.

A molar ratio of the counter ion group of the first reagent to the inorganic substance in the wastewater is 1 to 6. The electrical charge of the counter ion group of the first reagent is opposite to the electrical charge of the inorganic substance. Without the influence of impurities which may form crystals at the same time, a molar ratio of the counter ion group of the first reagent to the inorganic substance in the wastewater is 1 to 3, and the electrical charge of the counter ion group of the first reagent is opposite to the electrical charge of the inorganic substance. In an embodiment, the inorganic substances in wastewater are fluoride ions, the first reagent is calcium chloride (CaCl₂), and a molar ratio of the counter ion group (i.e. calcium ion) of the first reagent to the inorganic substance (i.e. fluoride ion) in the wastewater is 1˜3; the crystals are calcium fluoride (CaF₂). In an embodiment, the inorganic substances in wastewater are calcium ions, the first reagent is sodium carbonate (Na₂CO₃), and a mole ratio of the counter ion group (i.e. carbonate) of the first reagent to the inorganic substance (i.e. calcium ion) in the wastewater is 1 to 1.5; the crystals are calcium carbonate (CaCO₃). In an embodiment, the inorganic substances in wastewater are nickel ions, the first reagent is sodium carbonate (Na₂CO₃), and a molar ratio of the counter ion group (i.e. carbonate) of the first reagent to the inorganic substance (i.e. nickel ion) in the wastewater is 2 to 3.5; the crystals are nickel carbonate (NiCO₃). When a molar ratio of the counter ion group of the first reagent to the inorganic substance in the wastewater is within the above range, the removal efficiency of the inorganic substances can be improved.

In the fluidized bed reactor 10, a surface loading of the inorganic substances in the wastewater is 1 mole/m² h to 160 mole/m² h. In an embodiment, the inorganic substances in the wastewater are fluoride ions, and the surface loading of fluoride ions is 26 mole/m² h to 158 mole/m² h. In an embodiment, the inorganic substances in the wastewater are calcium ions, and the surface loading of calcium ions is 15 mole/m² h to 125 mole/m² h. In an embodiment, the inorganic substances in the wastewater are nickel ions, and the surface loading of nickel ions is 1 mole/m² h to 51 mole/m² h. When the surface loading of the inorganic substances is within the above range, the removal efficiency of the inorganic substances can be improved. The surface loading is the amount of inorganic substances in mole removed by one unit of cross-sectional area (unit: m²) of the tank 100 per unit of time (unit: hour (h)).

In the fluidized bed reactor 10, a hydraulic retention time (HRT) of the wastewater is 5 minutes to 250 minutes. In an embodiment, the inorganic substances in the wastewater are fluoride ions, and the hydraulic retention time of the wastewater is 50 minutes to 250 minutes. In an embodiment, the inorganic substances in the wastewater are calcium ions, and the hydraulic retention time of the wastewater is 5 minutes to 60 minutes. In an embodiment, the inorganic substances in the wastewater are nickel ions, and the hydraulic retention time of the wastewater is 15 minutes to 60 minutes. When the hydraulic retention time is within the above range, the removal efficiency of the inorganic substances can be improved. The hydraulic retention time is an average residence time of the wastewater to be treated in the tank 100. The hydraulic retention time can be represented by the following formula (1).

$$hydraulic retention time ( min ) = \frac{Volume of tank 100 ( mL )}{flow rate ( mL / min )} \qquad formula ( 1 )$$

After the crystals 121 are formed (or when the particle sizes of the crystals 121 reach required sizes), the carriers 120 and the crystals 121 formed on the outer surfaces of the carriers 120 can be discharged from the fluidized bed reactor 10 through the crystal outlet 157 connected the pipe 112, and can be introduced into the crystal dissolving tank 30. The treated solution can be removed from the fluidized bed reactor 10 through the pipe 111 and the outlet 155. In an embodiment, the amount of the inorganic substances in the treated solution complies with the Effluent Standards. Then, a second reagent can be introduced into the crystal dissolving tank 30 to dissolve the crystals 121 to form a recovered solution containing at least part of the inorganic substances. At this stage, the fluid 330 includes the recovered solution and may further include part of the unreacted second reagent. After the crystals are dissolved, the carriers 120 can be reused.

The second reagent is different from the first reagent. The second reagent may include sulfuric acid, hydrochloric acid or combinations thereof. In an embodiment, the second reagent is 0.3 wt % hydrochloric acid or 3 wt % sulfuric acid. In an embodiment, the crystals are calcium carbonate (CaCO₃), the second reagent is 0.3 wt % hydrochloric acid, and a concentrated calcium chloride solution can be formed. In an embodiment, the crystals are nickel carbonate (NiCO₃), the second reagent is hydrochloric acid, and a concentrated nickel chloride solution can be formed. In an embodiment, the crystals are calcium fluoride (CaF₂), the second reagent is concentrated sulfuric acid, and calcium sulfate and anhydrous hydrofluoric acid with high purity can be formed.

In the crystal dissolving tank 30, the crystals 121 are dissolved in the second reagent, but the carriers 120 are almost insoluble in the second reagent. As such, the generation of impurities (such as substances formed by dissolved carriers) can be reduced or avoided, inorganic substances with high purity can be recovered, and the carriers 120 can be reused. The recovery rate of carriers according to the present disclosure can be more than 98%, such as 98%˜99%.

The method for removing inorganic substances from wastewater according to the present disclosure will be explained in further detail with reference to experimental examples and comparative examples.

Experimental examples 1 to 7 use calcium chloride (CaCl₂)) as the first reagent to treat fluoride-containing wastewater actually produced by the factory, and the operating conditions are shown in Table 1 below. Test results of treated solution are shown in Table 2 below. The crystals are CaF₂. The carriers used in experimental example 1 are reused as the carriers in experimental examples 2 and 3. After using 0.3 wt % hydrochloric acid as the second reagent to dissolve the crystals in experimental example 1, the carriers are recovered to perform the wastewater treatments of experimental examples 2 and 3. The carriers used in experimental example 4 and 5 are reused as the carriers in experimental examples 6 and 7 respectively. After using 0.3 wt % hydrochloric acid as the second reagent to dissolve the crystals in experimental examples 4 and 5, the carriers are recovered to perform the wastewater treatments of experimental examples 6 and 7.

TABLE 1

| | | | | Ca²⁺ | | |
|---|---|---|---|---|---|---|
| | Major | | F⁻ | concentration | | |
| | inorganic | | concentration | in first | Surface | |
| Experimental | substances | | in wastewater | reagent | loading | HRT |
| Example | in wastewater | Carrier | (mg/L) | (mg/L) | (kg/m²h) | (min) |
| 1 | Fluoride ion | White | 1,065 | 1,591 | 0.5 | 67 |
| 2 | | fused | 1,090 | 1,600 | 0.6 | 63 |
| 3 | | alumina | 1,090 | 1,600 | 3 | 18 |
| 4 | | PVDF | 1,405 | 2,942 | 1.2 | 74 |
| 5 | | | 1,405 | 2,942 | 3 | 31 |
| 6 | | | 1,405 | 2,942 | 1.2 | 74 |
| 7 | | | 1,405 | 2,942 | 3 | 31 |

*Composition of white fused alumina:
Al₂O₃ ≥ 99.2 wt %
SiO₂ ≤ 0.1 wt %
Na₂O ≤ 0.3 wt %
H₂O ≤ 0.2 wt %

TABLE 2
Test results of treated solution

| Experimental | F⁻ | | Suspended solids |
|---|---|---|---|
| Example | concentration (mg/L) | pH | (mg/L) |
| 1 | 5.5 | 6.32 | 126 |
| 2 | 3.43 | 6.49 | 142 |
| 3 | 2.97 | 6.65 | 907 |
| 4 | 2.42 | 6.19 | 72 |
| 5 | 2.87 | 5.14 | 460 |
| 6 | 3.81 | 6.5 | 67 |
| 7 | 4.04 | 5.43 | 352 |

As shown in Table 2, the method for removing fluorine inorganic substances from wastewater according to the present disclosure can effectively reduce the amount of fluoride in the wastewater, the amount of fluoride in the treated solution meet the requirement for discharge into the environment, and alkaline compounds are added to the treated solution in a neutralization tank at the next stage to bring the treated solution's pH to a neutral pH and make the treated solution comply with discharge standards. Under similar surface loading, there is no significant difference in concentration of fluoride, pH value and concentration of suspended solids of the treated solutions between experimental example 1 and experimental examples 2˜3, which means that the carriers used in the present disclosure are reusable and reused carriers can produce the same excellent treatment results. Under similar surface loading, there is no significant difference in concentration of fluoride, pH value and concentration of suspended solids of the treated solutions between experimental examples 4˜5 and experimental examples 6˜7, which means that the carriers used in the present disclosure are reusable and reused carriers can produce the same excellent treatment results.

Experimental examples 8 to 19 use sodium carbonate (Na₂CO₃) as the first reagent to treat the calcium-containing wastewater, and the operating conditions are shown in Table 3 below. Test results of treated solution are shown in Table 4 below. The crystals are CaCO₃. The carriers used in experimental examples 8 to 10 are reused as the carriers in experimental examples 11 to 13 respectively. After using 0.3 wt % hydrochloric acid as the second reagent to dissolve the crystals in experimental examples 8 to 10, the carriers are recovered to perform the wastewater treatments of experimental examples 11 to 13. The carriers used in experimental examples 14 to 16 are reused as the carriers in experimental examples 17 to 19 respectively. After using 0.3 wt % hydrochloric acid as the second reagent to dissolve the crystals in experimental examples 14 to 16, the carriers are recovered to perform the wastewater treatments of experimental examples 17 to 19.

TABLE 3

| | | | Ca²⁺ | CO₃²⁻ | | |
|---|---|---|---|---|---|---|
| | Inorganic | | concentration | concentration | Surface | |
| Experimental | substances | | in wastewater | in first reagent | loading | HRT |
| Example | in wastewater | Carrier | (mg/L) | (mg/L) | (kg/m²h) | (min) |
| 8 | Calcium ion | White | 907 | 1,767 | 1 | 50 |
| 9 | | fused | | | 3 | 17 |
| 10 | | alumina | | | 5 | 10 |
| 11 | | | | | 1 | 50 |
| 12 | | | | | 3 | 17 |
| 13 | | | | | 5 | 10 |
| 14 | | PVDF | 840 | 2,000 | 0.5 | 84 |
| 15 | | | | | 1 | 42 |
| 16 | | | | | 2 | 21 |
| 17 | | | | | 0.5 | 84 |
| 18 | | | | | 1 | 42 |
| 19 | | | | | 2 | 21 |

*Composition of white fused alumina:
Al₂O₃ ≥ 99.2 wt %
SiO₂ ≤ 0.1 wt %
Na₂O ≤ 0.3 wt %
H₂O ≤ 0.2 wt %

TABLE 4
Test results of treated solution

| Experimental | Ca²⁺ | | Suspended solids |
|---|---|---|---|
| Example | concentration (mg/L) | pH | (mg/L) |
| 8 | 7 | 9.8 | 125 |
| 9 | 8.6 | 9.7 | 101 |
| 10 | 7.6 | 9.6 | 84 |
| 11 | 13.1 | 9.7 | 114 |
| 12 | 11 | 9.5 | 70 |
| 13 | 6.9 | 9.7 | 36 |
| 14 | 1.29 | 10.98 | 151 |
| 15 | 1.29 | 10.89 | 116 |
| 16 | 1.13 | 10.92 | 93 |
| 17 | 1.53 | 10.96 | 147 |
| 18 | 1.48 | 10.93 | 122 |
| 19 | 1.36 | 10.95 | 104 |

As shown in Table 4, the method for removing calcium ion from wastewater according to the present disclosure can effectively reduce the amount of the calcium in the wastewater, the amount of calcium in the treated solution is much less than the input amount, and acidic compounds are added to the treated solution in a neutralization tank at the next stage to bring the treated solution's pH to a neutral pH and make the treated solution comply with discharge standards. Moreover, there is no significant difference in concentration of calcium ions, pH value and concentration of suspended solids of the treated solutions between experimental examples 8˜10 and experimental examples 11˜13, which means that the carriers used in the present disclosure are reusable and reused carriers can produce the same excellent treatment results. There is no significant difference in concentration of calcium ions, pH value and concentration of suspended solids of the treated solutions between experimental examples 14˜16 and experimental examples 17˜19, which means that the carriers used in the present disclosure are reusable and reused carriers can produce the same excellent treatment results.

Experimental examples 20 to 31 use sodium carbonate (Na₂CO₃) as the first reagent to treat the nickel-containing wastewater, and the operating conditions are shown in Table 5 below. Test results of treated solution are shown in Table 6 below. The crystals are NiCO₃. The carriers used in experimental examples 20 to 22 are reused as the carriers in experimental examples 23 to 25 respectively. After using 0.3 wt % hydrochloric acid as the second reagent to dissolve the crystals in experimental examples 20 to 22, the carriers are recovered to perform the wastewater treatments of experimental examples 23 to 25. The carriers used in experimental examples 26 to 28 are reused as the carriers in experimental examples 29 to 31 respectively. After using 0.3 wt % hydrochloric acid as the second reagent to dissolve the crystals in experimental examples 26 to 28, the carriers are recovered to perform the wastewater treatments of experimental examples 29 to 31.

TABLE 5

| | | | Ni²⁺ | CO₃²⁻ | | |
|---|---|---|---|---|---|---|
| | Inorganic | | concentration | concentration | Surface | |
| Experimental | substances | | in wastewater | in first reagent | loading | HRT |
| Example | in wastewater | Carrier | (mg/L) | (mg/L) | (kg/m²h) | (min) |
| 20 | Nickel ion | White | 533 | 2,361 | 0.5 | 50 |
| 21 | | fused | | | 1 | 28 |
| 22 | | alumina | | | 2 | 15 |
| 23 | | | | | 0.5 | 50 |
| 24 | | | | | 1 | 28 |
| 25 | | | | | 2 | 15 |
| 26 | | PVDF | 56.2 | 2,000 | 0.03 | 99 |
| 27 | | | | | 0.06 | 50 |
| 28 | | | | | 0.12 | 25 |
| 29 | | | | | 0.03 | 99 |
| 30 | | | | | 0.06 | 50 |
| 31 | | | | | 0.12 | 25 |

*Composition of white fused alumina:
Al₂O₃ ≥ 99.2 wt %
SiO₂ ≤ 0.1 wt %
Na₂O ≤ 0.3 wt %
H₂O ≤ 0.2 wt %

TABLE 6
Test results of treated solution

| Experimental | Nickel ion | | Suspended solids |
|---|---|---|---|
| Example | concentration (mg/L) | pH | (mg/L) |
| 20 | 0.03 | 10 | 76 |
| 21 | 0.13 | 9.9 | 34 |
| 22 | 0.03 | 9.8 | 18 |
| 23 | 0.1 | 10 | 70 |
| 24 | 0.79 | 9.9 | 40 |
| 25 | 0.44 | 9.8 | 32 |
| 26 | 0.82 | 9.95 | 92 |
| 27 | 0.53 | 9.97 | 64 |
| 28 | 0.67 | 9.89 | 45 |
| 29 | 0.77 | 10.1 | 111 |
| 30 | 0.83 | 9.92 | 85 |
| 31 | 0.86 | 9.95 | 53 |

As shown in Table 6, the method for removing nickel inorganic from wastewater according to the present disclosure can effectively reduce the amount of the nickel in the wastewater, the amount of nickel in the treated solution is less than the requirement to discharge into the environment, and acidic compounds are added to the treated solution in a neutralization tank at the next stage to bring the treated solution's pH to a neutral pH and make the treated solution comply with discharge standards. Moreover, there is no significant difference in concentration of nickel ions, pH value and concentration of suspended solids of the treated solutions between experimental examples 20˜22 and experimental examples 23˜25, which means that the carriers used in the present disclosure are reusable and reused carriers can produce the same excellent treatment results. There is no significant difference in concentration of nickel ions, pH value and concentration of suspended solids of the treated solutions between experimental examples 26˜28 and experimental examples 29˜31, which means that the carriers used in the present disclosure are reusable and reused carriers can produce the same excellent treatment results.

0.3 wt % hydrochloric acid is used as the second reagent to dissolve the crystals in experimental examples 20 to 25 to form recovered solution containing nickel. Test results of recovered solution are shown in Table 7 below.

TABLE 7
Test results of recovered solution

| Experimental | Nickel ion | Nickel weight | Recovery rate |
|---|---|---|---|
| Example | concentration (mg/L) | (g) | (%) |
| 20 | 26.09 | 11.48 | 94 |
| 21 | | | |
| 22 | | | |
| 23 | 17.74 | 8.34 | 95 |
| 24 | | | |
| 25 | | | |

0.3 wt % hydrochloric acid is used to dissolve the crystals CaF₂ formed on the outer surfaces of white fused alumina carriers in experimental examples 1 to 3, the crystals CaCO₃ formed on the outer surfaces of white fused alumina carriers in experimental examples 8˜13, and the crystals NiCO₃ formed on the outer surfaces of white fused alumina carriers in experimental examples 20 to 25, and then inductively coupled plasma (ICP) is used to determine the purity of the crystal. The analytical results are shown in Table 8 below. Concentrated hydrochloric acid is used to dissolve the crystals CaF₂ formed on the outer surfaces of PVDF carriers in experimental examples 4 to 7, the crystals CaCO₃ formed on the outer surfaces of PVDF carriers in experimental examples 14˜19, and the crystals NiCO₃ formed on the outer surfaces of PVDF carriers in experimental examples 26 to 31, and then inductively coupled plasma (ICP) is used to determine the purity of the crystal. The analytical results are shown in Table 9 below.

TABLE 8

| | Total | | | | | | |
|---|---|---|---|---|---|---|---|
| | amount of | Amount of | Amount of | Amount of | Amount of | Amount of | Amount of |
| | metal | calcium | calcium | calcium | calcium | nickel | nickel |
| Crystal | (mmole) | (mmole) | (%) | (mmole) | (%) | (mmole) | (%) |
| CaF₂ | 2.3 | 2.25 | 97.1 | | — | | — |
| CaCO₃ | 1.59 | | — | 1.55 | 97.4 | | — |
| NiCO₃ | 101 | | — | | — | 92 | 90.8 |

TABLE 9

| | Total | | | | | | |
|---|---|---|---|---|---|---|---|
| | amount of | Amount of | Amount of | Amount of | Amount of | Amount of | Amount of |
| | metal | calcium | calcium | calcium | calcium | nickel | nickel |
| Crystal | (mmole) | (mmole) | (%) | (mmole) | (%) | (mmole) | (%) |
| CaF₂ | 4.98 | 4.91 | 98.6 | | — | | — |
| CaCO₃ | 6.2 | | — | 6.07 | 98 | | — |
| NiCO₃ | 4 | | — | | — | 3.24 | 90 |

As shown in Tables 7 to 9, the recovery purity of the present disclosure is between 90 and 99%.

The carriers used in experimental example 8 are replaced with brown fused alumina, silica sand, fluorite, diaspore and flint clay, and the operating conditions are not changed. The treatment results are shown in Table 10 below. 0.3 wt % hydrochloric acid is used as the second reagent to dissolve the crystals CaCO₃ to form recovered solution.

TABLE 10

| | | Composition of | Density of carrier | Composition of | recovered |
|---|---|---|---|---|---|
| | Carrier | carrier | (g/cm³) | recovered solution | solution |
| Experimental | White fused | Al₂O₃ ≥ 99.2 wt % | 3.5 | CaCl₂ | can be |
| Example 8 | alumina | SiO₂ ≤ 0.1 wt % | | | recycled and |
| | | Na₂O ≤ 0.3 wt % | | | reused |
| | | H₂O ≤ 0.2 wt % | | | |
| Experimental | Brown fused | Al₂O₃ ≥ 95 wt % | 3.8 | CaCl₂ | can be |
| example 8A | alumina | Fe₂O₃ ≤ 0.4 wt % | | | recycled and |
| | | SiO₂ ≤ 1.5 wt % | | | reused |
| | | TiO₂ ≤ 3 wt % | | | |
| | | H₂O ≤ 0.2 wt % | | | |
| Comparative | Silica sand | SiO₂ ≥ 95 wt % | 2.6 | CaCl₂ | contains various |
| example 1 | | Al₂O₃ ≤ 0.071 wt % | | FeCl₃ | impurities and |
| | | Fe₂O₃ ≤ 0.01 wt % | | other | cannot be |
| | | other constituents | | constituents | recycled and |
| | | | | | reused |
| Comparative | Fluorite | CaF₂ ≥ 60 wt % | 3.18 | CaCl₂ | contains various |
| example 2 | | SiO₂ ≤ 19.8 wt % | | HF | impurities and |
| | | CaCO₃ ≤ 15 wt % | | FeCl₃ | cannot be |
| | | Fe₂O₃ ≤ 0.46 wt % | | | recycled and |
| | | | | | reused |
| Comparative | Diaspore | Al₂O₃ ≥ 85 wt % | 3.05 | CaCl₂ | contains various |
| example 3 | | Fe₂O₃ ≤ 2 wt % | | FeCl₃ | impurities and |
| | | SiO₂ ≤ 7 wt % | | | cannot be |
| | | TiO₂ ≤ 4 wt % | | | recycled and |
| | | H₂O ≤ 0.5 wt % | | | reused |
| Comparative | Flint clay | Al₂O₃ ≥ 45 wt % | 2.45 | CaCl₂ | contains various |
| example 4 | | Fe₂O₃ ≤ 1.5 wt % | | FeCl₃ | impurities and |
| | | SiO₂ ≤ 50 wt % | | | cannot be |
| | | H₂O ≤ 0.5 wt % | | | recycled and |
| | | | | | reused |

As shown in Table 10, as compared with experimental examples 8 and 8A, the carriers used in comparative examples 1 to 4 results in various impurities in the recovered solution, and recovery of high-purity inorganic substances for reuse is difficult. The present disclosure uses alumina (Al₂O₃) with more than 95 wt % purity as carriers, so that there is almost no loss when dissolving crystals, the carriers can be reused, and high-purity inorganic substances can be recovered from wastewater.

Physical properties and Chemical resistances of various organic carriers are shown in Table 11. Chemical resistance is the ability of an organic carrier to endure itself from chemical attack of chemical reagent (e.g. ability to prevent chemical corrosion or reaction with solvents). In Table 11, “A” represents no effect, “B” represents minor effect, “C” represents moderate effect, “D” represents severe effect (not recommended), and “—” means no data available.

TABLE 11

| Carrier | | PVDF | ETFE | PTFE | PMMA | ABS | PP | HDPE |
|---|---|---|---|---|---|---|---|---|
| Physical | Density | 1.75 | 1.7 | 2.17 | 1.2 | 1.04 | 0.9 | 0.95 |
| properties | (g/cm³) | | | | | | | |
| | Maximum | 150 | 150 | 260 | 50 | 100 | 135 | 120 |
| | temperature | | | | | | | |
| | for usage | | | | | | | |
| | (° C.) | | | | | | | |
| Chemical | H₂SO₄ | A | A | A | B | B | A | A |
| resistances | (<10%) | | | | | | | |
| | H₂SO₄ | A | A | A | C | B | A | A |
| | (10%~75%) | | | | (<30%) | | | |
| | H₂SO₄ | A | A | A | D | — | C | B |
| | (75%~100%) | | | | | | | |
| | HCl (20%) | A | A | A | — | — | — | — |
| | HCl (37%) | A | A | A | — | A | C | A |
| | HCl dry gas | A | A | A | — | — | B | D |
| | HCl (100%) | A | A | A | — | A | B | D |
| | HF (20%) | A | A | A | — | C | A | A |
| | HF (50%) | A | A | A | — | C | A | A |
| | HF (75%) | A | A | A | — | C | C | B |
| | HF (100%) | A | A | A | — | D | C | D |

As shown in Table 11, when using PMMA (polymethyl methacrylate), ABS (acrylonitrile-butadiene-styrene copolymer), PP (polypropylene) or HDPE (high-density polyethylene) as carriers, the second reagent will moderately or severely affect these carriers. The carriers will be damaged so that it will be difficult to reuse, and impurities will be formed in the recovered solution to reduce the purity. When using PMMA, ABS, PP or HDPE as carriers, the chemical reagents that can be used are limited, which is disadvantageous to application in various types of wastewater. Moreover, the densities of PP and HDPE are less than 1, which means that such carriers will be suspended in the fluid and flow out from the pipe 111 located at the upper part of the tank, and the crystallization efficiency is reduced. PTFE (polytetrafluoroethylene) has strong hydrophobicity, and therefore it will aggregate in the fluidized bed reactor and be difficult to fluidize; the crystallization efficiency is poor. The present disclosure uses PVDF and ETFE as carriers; as compared with the carriers shown in Table 11 (except PTFE), PVDF and ETFE are relatively temperature-resistant, relatively hydrophilic, and have good resistance to various chemical reagents; that is, PVDF and ETFE carriers are hardly damaged when dissolving crystals, the carriers can be reused, and high-purity inorganic substances can be recovered from wastewater.

According to above embodiments, the present disclosure provides a method for removing inorganic substances from wastewater, the method for removing inorganic substances from wastewater uses polyvinylidene fluoride (PVDF), ethylene tetrafluoroethylene (ETFE), or alumina (Al₂O₃) with purity more than 95 wt % as carriers to effectively reduce the amount of inorganic substances in wastewater, the treated wastewater comply with discharge standards, and high-purity inorganic substances can be recovered from the wastewater for recycling. Furthermore, the carriers used in the present disclosure can be reused, the reusable carriers have excellent performance on wastewater treatment and make the treated wastewater comply with discharge standards.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for removing inorganic substances from wastewater, comprising:
providing a fluidized bed reactor, wherein carriers are added into the fluidized bed reactor, and the carriers comprises polyvinylidene fluoride (PVDF), ethylene tetrafluoroethylene (ETFE), alumina (Al₂O₃) with purity more than 95 wt %, or combinations thereof;
introducing the wastewater containing the inorganic substances and a first reagent into the fluidized bed reactor; and
fluidizing the carriers in the fluidized bed reactor, and making the inorganic substances in the wastewater reacting with the first reagent to form crystals, wherein the crystals are formed on the outer surfaces of the carriers.

2. The method according to claim 1, further comprising:
providing a crystal dissolving tank;
discharging the crystals and the carriers from the fluidized bed reactor and introducing the crystals and the carriers into the crystal dissolving tank; and
introducing a second reagent into the crystal dissolving tank to dissolve the crystals to form a recovered solution containing at least part of the inorganic substances, wherein the second reagent is different from the first reagent.

3. The method according to claim 1, wherein the second reagent comprises sulfuric acid, hydrochloric acid or combinations thereof.

4. The method according to claim 1, wherein the carriers are polyvinylidene fluoride (PVDF) or ethylene tetrafluoroethylene (ETFE), and the carriers have a particle size of 0.1 mm˜2 mm and a density between 1.5 g/cm³ and 2 g/cm³.

5. The method according to claim 1, wherein the carriers are alumina (Al₂O₃) with purity more than 95 wt %, and the carriers have a particle size of 0.1 mm˜1 mm and a density between 2.6 g/cm³ and 4 g/cm³.

6. The method according to claim 1, wherein the carriers are white fused alumina or brown fused alumina.

7. The method according to claim 1, wherein the inorganic substances comprises fluoride ion, nitrogen ion, phosphate ion, arsenic ion, calcium ion, nickel ion, magnesium ion, iron ion, lead ion, cobalt ion, zinc ion, cadmium ion, manganese ion, copper ion, or combinations thereof.

8. The method according to claim 1, wherein the first reagent comprises halide, carbonate, bicarbonate, or combinations thereof.

9. The method according to claim 1, wherein in the fluidized bed reactor, the surface loading of the inorganic substances is 1 mole/m² h˜160 mole/m² h, and the hydraulic retention time of the wastewater is 5 minutes˜250 minutes.

10. The method according to claim 1, further comprising:
introducing a sodium hydroxide solution into the fluidized bed reactor;
mixing the wastewater, the first reagent and the sodium hydroxide solution in the fluidized bed reactor, and fluidizing the carriers in the fluidized bed reactor.
